(19) United States
(12) Patent Application Publication
(10) Pub. No.: US 2021/0164203 A1
(43) Pub. Date: Jun. 3, 2021

(54) FOOT ACTUATED CONTACTLESS ELECTRONICALLY CONTROLLED DEVICE

(71) Applicants: Nagesh Siddabasappa Mavinahally, Granada Hills, CA (US); Vinayaka Shanmukappa Mavinahalli, Shanivarasanthe (IN); Dhanush Mahesh Mavinahally, Hippali (IN)

(72) Inventors: Nagesh Siddabasappa Mavinahally, Granada Hills, CA (US); Vinayaka Shanmukappa Mavinahalli, Shanivarasanthe (IN); Dhanush Mahesh Mavinahally, Hippali (IN)

(21) Appl. No.: 16/699,657

(22) Filed: Dec. 1, 2019

(51) Int. Cl. E03C 1/05; A47K 5/12

(52) U.S. Cl. CPC E03C 1/057; G01S 17/04; E03C 1/052; A47K 5/1217

(57) ABSTRACT

The invention includes an assembly comprising a foot or lower body actuated contactless sensor and flow valve assembly for remotely controlling the flow of fluid in faucets and showers and the assembly includes a contactless sensor to trigger at least one electromechanical (solenoid) valve to turn on and off the flow as desired by the user. The actuation logic includes a trigger such as motion or interruption of wireless signal by the foot or the leg from one position to the second position. The idle/off condition is disrupted by the pre-determined triggering action. In another embodiment an infrared signal emitting sensor is embedded in to the floor mat and the infrared signal is emitted upward. A human foot over the sensor triggers the solenoid valve to open and removal of the foot over the sensor or after elapsing of a fixed time, the solenoid valve is closed.

### RELATED APPLICATIONS

The present application claims the benefit of priority of U.S. Provisional Patent application No. 62/735,055, filed Sep. 22, 2018, entitled “FOOT ACTUATED ELECTRONIC FLOW CONTROL SYSTEM FOR FAUCET”

### FIELD OF INVENTION

The present invention relates to remotely controlled flow control valve, particularly for turning the faucet or shower water flow on and off by the motion of the foot or lower body of the user. The assembly includes at least one contactless sensor and at least one electromechanically actuated valve. The assembly optionally includes a pre-programmed electronic board for the logical control of the valve.

### PRIOR ARTS

U.S. Pat. No. 7,997,301B2 Aug. 16, 2011 Spout assembly for an electronic faucet, U.S. Pat. No. 7,627,909B2 Aug. 12, 2009 Faucet sensor mounting assembly, U.S. Pat. No. 7,174,577B2 Feb. 13, 2007 Automatic proximity faucet, U.S. Pat. No. 7,150,293B2 Dec. 19, 2006 Multi mode hands free automatic faucet, U.S. Pat. No. 6,513,787B1 Feb. 4, 2003 Touchless fluid supply interface and apparatus, US20100071126A1 Mar. 25, 2010 Faucet controlled in a contactless manner, US20090100593A1 Apr. 23, 2009 Automatic hand washing system, US20080283786A1 Nov. 20, 2008 Infrared retrofit faucet controller, EP1019791B1 Dec. 6, 2002 Water faucet with touchless control, EP0921238A1 Sep. 6, 1999 Electrically controlled water tap, US2014/0156112 Jun. 5, 2014 Hands-free power tailgate system and method of controlling the same, U.S. Pat. No. 9,470,033 Oct. 18, 2016 System and method for controlling vehicle access component, U.S. Ser. No. 10/423,241 Oct. 24, 2019 Defining operating areas for virtual reality system using sensor-equipped operating surfaces.

### DESCRIPTION

Many contactless control valves for faucets have been in use for many years and there are many prior arts. The prior arts include contactless switches/sensors mounted on the faucet and hand or any object waved by the hand in front of the sensor actuates the valve and there are also foot pedal operated valves to control the flow. However, for example if the user wants to continue scrubbing an object without the flow, the current prior arts require that the hand or the object is moved away from the sensor, which is not desirable if the object is large or if the soap or dirt is not desired to fall on other objects in the sink. In the case of the mechanical foot pedal operated valves, the foot has to press a spring loaded pedal or stand on it, which is not a natural posture. The current invention provides a better solution in which the sensor is mounted away from the faucet and below the faucet and the valve is actuated by the motion of the foot or the lower body, such as a leg. The foot motion can actuate more than one valve including the automatic contactless soap dispenser and a common valve for hot and cold water. The advantage with the current invention is that the sensor and the valve can be adopted to any faucet including the mechanically operated faucets and without disturbing the faucet itself and without adding on to the faucet. It requires only adaptation of the existing pipes with some new pipes or plumbing below the sink. The sensors are below the faucet and attached to the frame or cabinet door. The valve is actuated by the motion of the foot or the leg. A pre-programmed electronic control unit can automatically actuate the electromechanical valve that has stayed off for more than a pre-determined period of time and after detecting a pre-determined number of stimuli and it can also deactivate by detecting a single stimuli and reactivate the electromechanical valve with another single stimuli as long as the stimuli is on and if the reactivation occurred within a pre-determined period of time. A second sensor mounted within a pre-determined distance from the first sensor can actuated an automatic soap dispenser as long as the stimuli is on. The electromechanical valve is operated by a DC power supply, which can be either a set of batteries or directly connected to AC power outlet. The control valve assembly may include a manual bypass valve to over ride the shut position of the electromechanical valve in case power supply is disrupted. The electromechanical valve assembly receives the single inlet water supply coming from the mixer of hot and cold water or just cold water as the original water supply system consists of and the water flows through the electromechanical valve assembly and has an outlet that is connected to the faucet. There can be multiple solenoid valves to vary the flow rate or a single valve to regulate the flow rate. The sensor can be a camera, active or a passive IR sensor, optical sensor, capacitor and the system can also vary the flow rate depending on the signal strength and position of the stimulating object, such as a foot or lower body's position or motion, including the speed at which the object moves. The flow rate can be varied by the number of solenoid valves actuated or how much a valve is opened. The system can also be voice actuated and recognize the words such as MORE/LESS/SOAP/WATER/STOP/START, etc. A manually operated valve is connected between the inlet and outlet to bypass the electromechanical valve to manually turn the valve on in case the power supply to the electromechanical valve is interrupted.

The advantage with the embodiment is that while the hands are busy cleaning or washing any object and if it is desired to momentarily stop the water, there is no need for interruption of action the hands are performing or moving the hands just to stop the water. Instead of hand the foot or the lower body can be moved to stop and start the water again. The embodiment provides a safe and hygienic faucet system to the health practitioners, as they do not have to touch the faucet or wave hand to open the faucet valve. The embodiment disclosed is guaranteed to save more water than the prior arts. The system can not only control water, but also disinfectants and other medically necessary fluids in a medical environment. Therefore, the embodiment is better for the environment and saves precious water from being wasted and it saves money and reduces carbon foot print in the form of reduced amount of energy required to pump less amount of water. It is roughly estimated that the embodiment disclosed when used efficiently reduces water approximately 10% or more.

### BRIEF DESCRIPTION OF DRAWINGS

FIG. 1 is a perspective view of the sink assembly 100 having the automatic faucet, plumbing, the sensor mounted at the bottom of the sink and showing position of the left foot when the valve is on.

FIG. 2 is the side view of the FIG. 1 as viewed from right.

FIG. 3 is the rear view of the FIG. 1.

FIG. 4 is the front view of the FIG. 1 with the foot removed.

FIG. 5 is a perspective view of the sink assembly 200 having the automatic faucet, cabinet, and the sensor mounted on the cabinet door.

FIG. 6 is a perspective view as viewed from the bottom of the sink assembly 220 having the automatic faucet, cabinet, and the sensor recessed inside the cabinet door.

FIG. 7 is the closeup view of the sensors and the cabinet door and the symbolic waves of the signal.

FIG. 8 is the side of the sink assembly 220 shown in FIG. 6.

FIG. 9 is the front sectional vie of the FIG. 8.

FIG. 10 shows close up view of the cut out in the frame/door for the sensors in sink assembly 220.

FIG. 11 shows sensors for water and soap emitting signals at different angles to one another.

FIG. 12 is a perspective view of pressure sensor mat 410 on the floor with the feet on the mats FIG. 13 shows FIG. 12 as viewed from the bottom.

FIG. 14 shows view of the sensor mats 410 attached to the floor.

FIG. 15 is the detailed schematic view of the automatic valve assembly 300.

FIG. 16 is the detailed schematic view of the automatic valve assembly 300 having multiple control valves.

FIG. 16a shows side view of a sink assembly having a post in the front.

FIG. 16b shows front view of FIG. 16a with the post offset to one side.

FIG. 16C Shows variation of the post having an offset base.

FIG. 17 shows the flow chart for the sink assembly having just one electromechanical valve for the water.

FIG. 18 shows the flow chart for the sink assembly having more than one electromechanical valve for the water.

FIG. 19 shows the flow chart for controlling the soap pump.

FIG. 20 shows flow chart for voice command controlling the automatic faucet and soap dispenser in sink assembly.

FIG. 21 shows perspective view of the mechanical assembly with the electromechanical valve 312 the manual bypass valve 134 having a tool pocket 133.

FIG. 22 shows top of the FIG. 21.

FIG. 23 shows from view of the FIG. 21.

FIG. 24 shows the perspective view of the integrated valve assembly 310a FIG. 25 shows side view of the FIG. 24.

FIG. 26 shows top view of the FIG. 25.

FIG. 27a shows a perspective view of a mat assembly having a sensor

FIG. 27b shows top of the mat assembly

FIG. 27c shows sectional view of the mat, sensor, and the wire harness

### DETAILED DESCRIPTION

With reference to the prior arts for the automatic faucets, the sensors are mounted on the spout of the faucet, above the sink and actuated by the touch or motion of a hand or motion of the upper body. Some prior arts have mechanical actuators at the ground level actuated by the foot.

The embodiments described here have contactless sensors mounted below the top level of the sink and actuated by the foot or the lower body. As such, in the preferred disclosed embodiment, the hand is completely free of requiring to actuate the sensor, irrespective of the type of the sensor or location of the sensor. The contactless system can actuate the faucet valve ON or OFF by the motion of the lower body and foot/leg in particular. In another embodiment the sensor with the electronic controller unit can vary the flow rate of the water depending on the stimuli and signal strength of the sensor. For example, in a light sensing sensor, the strength of the signal depends on the amount of light received by the receiver reflected from reflecting surface, which I turn can actuate the appropriate valve to vary the flow rate. The reflecting surface may be immovably attached to the floor or may be a floor mat having a reflective surface. The stimuli in this case may the foot blocking the light either fully or partially. Two light sensors may be used to actuate a hot and a cold-water valve depending on which sensor is blocked by the foot. Also, a logic can be adopted to actuate either just the cold water or the hot water valve. When the signals to both the valves are blocked, both the valves may be opened to get warm water. The principle of operation of a light sensing switch or a sensor is commonly known to anyone skilled in the art of switches and electronic controllers. Therefore, detailed description of the light sensing sensor or the logic is not explained in detail. An automatic soap dispenser can also be integrated into the electronic controller unit and the mechanical assembly. The Automatic faucet system can also have the ability to qualify the amount of water savings per pre-determined time period and communicate with the user. The automatic faucet can also be actuated by the sound such as a voice command, in which case the sound sensor is preferably mounted at a suitable height such as on the top of the sink or the in spout.

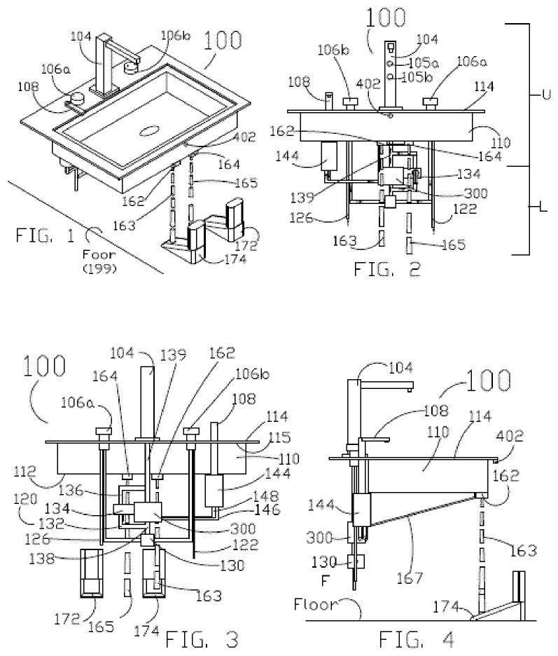

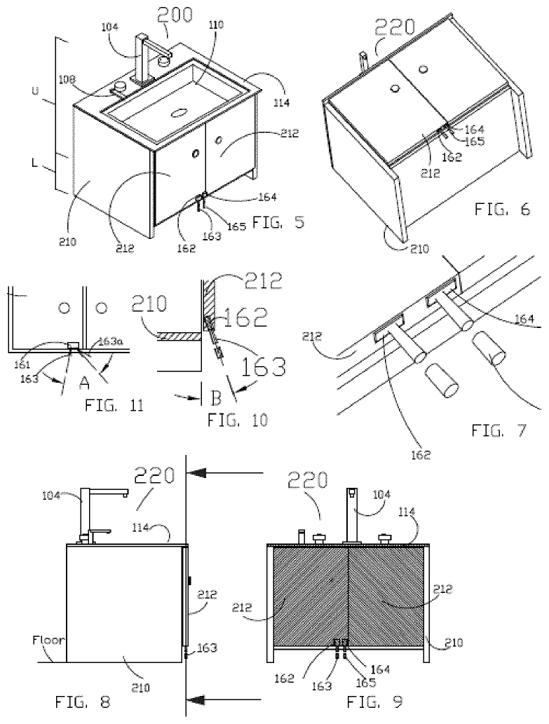

With reference to embodiment shown in FIGS. 1 through 4, the sink assembly 100 has an upper section U and a lower section U, as shown in FIG. 4. and consists of at least one faucet spout 104 for water, at least one handle 1 to manually regulate the water, sink 110 and at least one wireless signal generator and a wireless signal receiver (generator and receiver can be a single and integrated unit) known as sensor 162 such as for example an Infrared, light, or sonar. The sensor is fitted below the sink top 114 to the sink bottom 112 or to the lower face of the sink top in the upper section, and adopted to emitting wireless waves preferably downward toward the floor 199, a plumbing system 120, and a controller assembly 300 in the midsection that includes a portion of the upper and a portion of lower sections. The sensor attached to the sink is in the upper section. Water spout 104, manual handle 106a are above the sink top 114 and adopted to sit on the top of the sink.

The plumbing system 120 disposed underneath the sink consists of the water supply to the spout 104 through inlet 139 and supply is in series through at least one manual valve 106a and at least one electromechanical valve 312. A bypass valve 134, parallel to the electro mechanical valve 312 communicating with the electronic controller 160 for power, is provided to bypass the electromechanical valve 312. A bypass valve 134 is provided in case there is any electrical problem, which by default keeps the electromechanical valve 312 closed. The mechanical valve 134 shown in FIG. 4 has a handle 137 attached to the valve for opening and closing the manual valve as needed. Anyone skilled in the art of plumbing will know the inlet and outlets to connect to the faucet from the water supply line and therefore detail of the plumbing is not explained. Alternatively, the water inlet to the electromechanical valve can be connected directly from the main water supply line without the manual valve 106, handle 106 is a lever or a stem for opening and closing the manual valve adopted to the sink assembly in the top. An optional soap spout 108 is also shown in the sink assembly 100.

FIGS. 5 through 9 show sink assembly 200 and 220 having a cabinet 212 where in the sink 110 is resting on it and 212 extending from top to bottom portion with at least one door in the front. The sink assembly 200 and 220 are same as the sink assembly 100 and have all the elements described for 100 except that 200 and 220 have at least one sensor 162 attached at lower section of the cabinet or the door as shown in FIG. 5. The sensor in this instance is within 12 inches from the floor and preferably within a proximity of the human foot when standing in front of the faucet. FIGS. 6 through 9 show the sensor 162 installed in a recess in the door in the proximity of the floor. The sensor may be positioned at an angle to emit the wireless signal away from the door and have a wider field of view. The area on which signal may fall on the floor may be less than 9 square inches. Therefore, the foot that interrupts the signal should be within this area, specifically marked on the floor with some form of marking on through visible light. The sensor may also be attached to the frame of the cabinet. The sensor 162 is located in the cabinet or the door in the lower section U of the sink assemblies 200 and 220, shown in FIGS. 6 through 9. The sensor may be rectangular or cylindrical in shape that can be glued on the surface of the cabinet or the door, shown in FIGS. 5 and 11 or to the bottom of the sink. It can also be clamped using fasteners. Cylindrical sensors are easily inserted into the hole in the cabinet or door, as shown in FIG. 7. Aforementioned cabinet 210 consists of a frame supporting the sink 110 and at least one cabinet door 212.

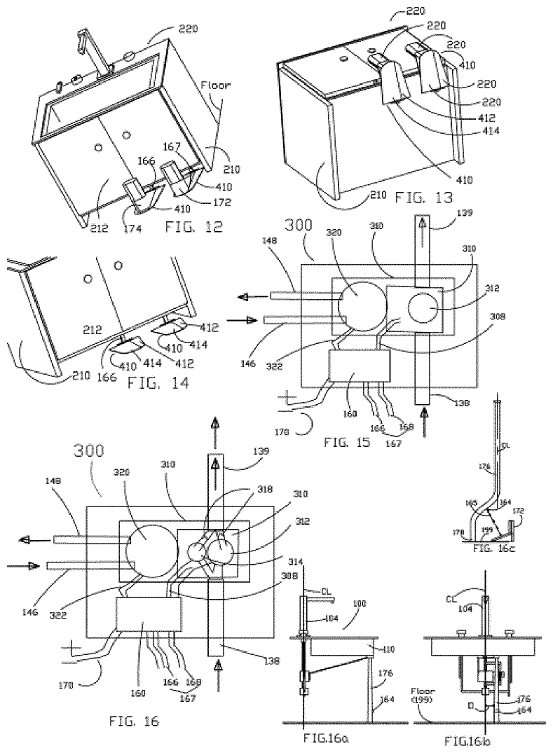

FIGS. 12 through 14 show another embodiment 240 consisting of the sink assembly described for embodiments 200 and 220, but has pressure sensor switches in the floor mat 410 resting on the floor to turn or off the faucet in response to application of weight or someone standing on the sensor. All the elements described for the embodiments 100, 200, and 220 are common to the embodiment 240, except for the sensors 162 and 164. Instead of wireless sensors, the electromechanical valve 312 is actuated when a person stands on the mat 410 and turned off automatically after a pre-determined period of time or when the foot 172 or human weight is lifted off the mat or whichever occurs first. Water flow rate in the faucet can be regulated by having more than one pressure sensor in the mat and the user would just move the foot to a new location within the marked area on the mat 410 or lean forward or backward to reduce or increase weight/pressure as a stimuli to actuate the appropriate electromechanical valve or valves. For example, the area marked 414 on the mat 410, shown in FIG. 14, may be for high flow rate and area 412 may be for lower flow rate. The programmable controller can be programmed to turn on the electromechanical valve at the first instance of pressure and reduce at the second instance irrespective of where the foot 172 or 174 is on the mat. The sensors in the mat are connected to the controller 300 either by means of a wire harness 166 or wirelessly. A soap dispenser may also be actuated by a similar mat by the other foot 174, as shown in FIG. 14. The sensor in the mat 410 can be embedded on to the mat and it can be a mechanical switch in the form of a spring actuated metal strip.

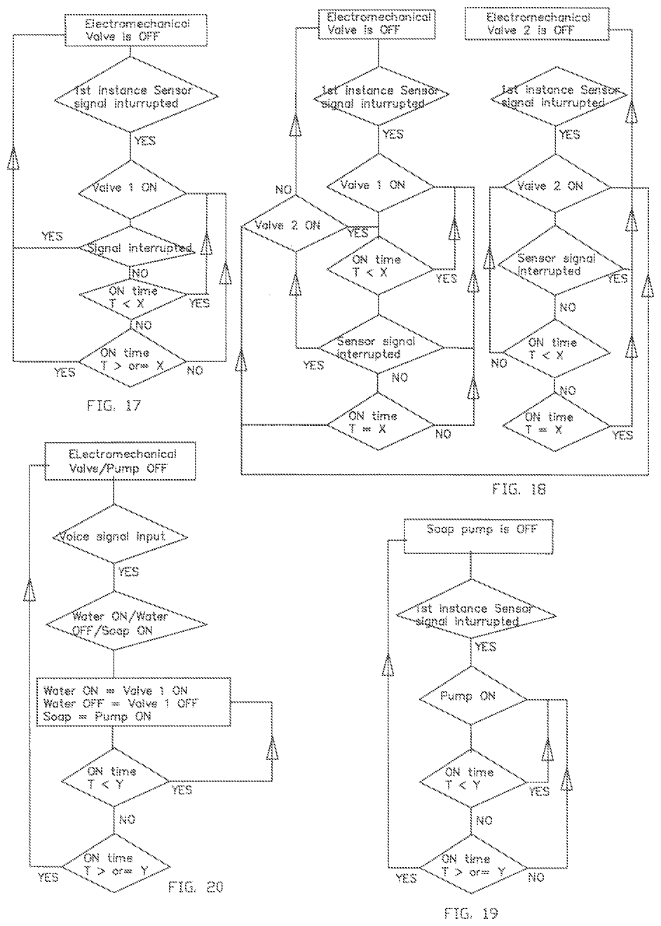

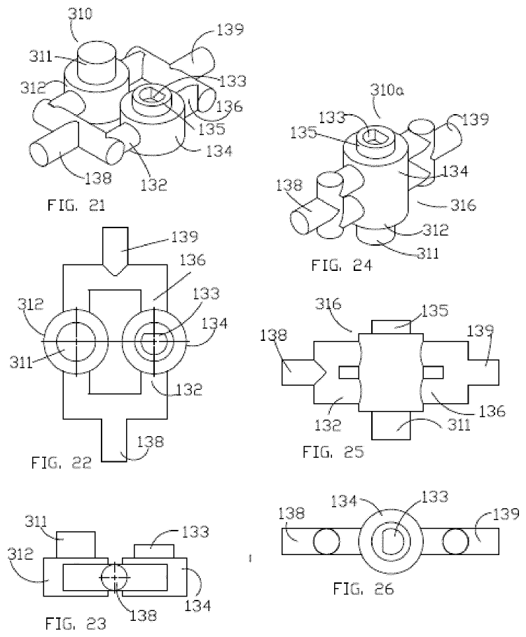

FIG. 16a and FIG. 16b illustrate the sink assembly 100 having a post 176 in the front of the sink assembly and is attached to the sink at the top and the lower end, the base 178 is resting on the floor 199. At least one sensor 162 is attached to the post 176 is attached to the post 176 at a height closer to the floor 199. The post 176 is slightly offset by a distance O from the centerline CL of the faucet spout and the objective is to keep the sensor or the signal right above the foot 172 from an ergonomic point of view. The post 176 is adjustable in height so as to attach the post 176 immovably between the sink and the floor and can be attached to any sink assembly as a retrofit assembly with the sensor 164 attached to it. The height of the post can be adjusted by many different ways that is commonly known. For example, top end of the post can have a threaded part that extends or retracts as it is turned in one direction or the other. Alternatively, it can have a telescoping type of columns that can be extended or retracted. The post may be attached to the bottom of the counter top of any sink assembly. FIG. 16c shows side view of the post 176 having the base 178 offset from the centerline CL of the post. The base 178 is offset inward to be slightly away from the toe of the foot, to prevent the foot from contact or hitting the post. The sensor 164 is in the section of the post that is transitioning from the vertical section to the offset base. The location of the sensor in the transitional section helps angularity of the signal as well as protects it from being accidentally hit by the foot. The sensor 164 is recessed from the outside surface of the post. There can be lip above the sensor to protect and many other forms can be incorporated to protect it from the external elements.

Controller assembly 300 shown in FIG. 16, has an electronic controller unit 160 that communicates with at least one electromechanical valve 312 to turn on and off the flow of water. The wire harness 168 and 170 from at least one sensor 162 and power from an external power supply 170 communicate with the electronic controller unit 160. The controller assembly 300 shown in FIG. 15 and FIG. 16 may also have an electrically operated pump 320 to dispense soap through the soap spout 108. However, having a pump for dispensing soap is optional.

The controller assembly 302 shown in FIG. 16 has identical components as described above for FIG. 15, but has at least two electromechanical valves 312 and 314 and each having approximately half the maximum flow rate when both the valves are open. The intent of having more than one valve is to vary the water flow rate depending on the requirement by the user and in response to the stimuli from at least one sensor 162. In order to prevent back flow of water into the electromechanical valve that is closed, a non-return valve 318 one each on outlet from the electromechanical valve is incorporated as shown in FIG. 16. A stepper motor controlled valve can also be used in lieu of multiple electromechanical valves. The stimuli for varying the flow rate would be the position of the foot/lower body and the signal value received in response to the stimuli. In a variable flow control system, the wireless signal can be emitted at wider angle and the receiver may receive the signal strength proportional to the stimuli, which is proportional to the exposure of the object and is of the order of a human foot, location or speed of motion of the foot or the lower body. An example would be how much of light is blocked by the foot for the receiver to receive the reflected signal or how much of IR signal is received. A second signal emitter and the receiver 164 is actuated in a similar way to 162 to dispense the soap as needed. The field of view of the sensor is predetermined and is at an angle in the vertical plane.

The signal emitter may be integrated with an LED (light emitting diode) to indicate to the user the area on the floor where the signal is to help place the foot to turn on/off the water.

The faucet spout has at least one red LED light 105a and at least one green LED light 105b to visually indicate high and low flow rates respectively. Longer the time the Green light is on during the usage, more saving is the water. High flow is indicated when the flow rate is maximum and green light when the flow rate is reduced by the stimuli.

The electronic controller unit 160 is programmable to keep the valve open to a pre-determined period of time once the valve is triggered to open and may have a clock to log the usage and interface wirelessly with an external electronic device, such as a phone or computer or store on the internet. The electronic controller unit 160 is programmed to disperse a pre-determined quantity of soap each time the user stimulates the sensor. The soap dispenser has its own sensor and is separate from the sensor for the water and is also triggered by the motion of the lower body, such as the foot. The sensors for water and soap dispensation may be integral but emit signals at different angles from one another, as shown in FIG. 11. The electronic controller unit 160 processes the input parameters received from at least one sensor and compares it with the pre-determined parameters, as shown in the flow charts FIG. 17 or 18 or 19, and sends signal to operate the applicable valve or the pump for a pre-determined length of time.

The purpose of keeping the electromechanical valve open only for a pre-determined period of time (like 60 or 180 seconds) at a time is to prevent wasting water if the valve is actuated to open position for other reasons than human interaction. When the valve is automatically shut closed after a pre-determined time or in response to stimuli, the valve is opened again by moving the lower body or the foot away from the sensor or through a predetermined distance or direction. The valve can also stay open as long as the signal is interrupted. The interruption of the signal means the IR is interrupted by the foot either in an active IR sensor or a passive sensor. In an active IR sensor, the emitter and the receiver are within the same sensor assembly and the foot reflects the IR light and triggers the sensor.

FIGS. 24 through 26 show the mechanical valve 134 having a pocket for receiving a special tool to turn on the valve on or off. As shown in Figures, the tool packet as a hole which is partially circular having a straight segment for receiving a male tool that matches the shape of the hole. The purpose of the special tool is to operate the bypass valve and prevent the valve from being turned on 100% of the time by the user, particularly when the embodiment is installed for saving the water consumption. FIGS. 26 through 25 show a unique valve assembly 310a, having an integral valve body 316 in which first section has a mechanical bypass valve 134 and the second section has a body of at least one electromechanical valve 312. The electromechanical valve has a solenoid or a stepper motor 311 to actuate the electromechanical to on/off position in response to the command received from the controller unit 160. The mechanical bypass valve 134 may also have a special pocket 133. The controller unit 160 may also be mounted on top of the solenoid.

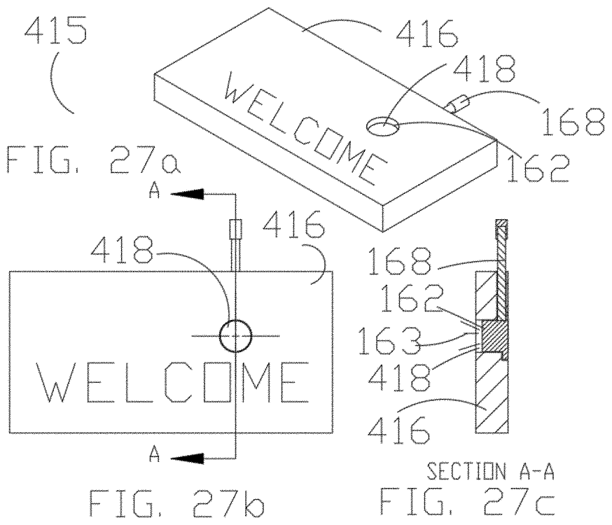

FIG. 26a through 26c show another embodiment 415 having a floor mat assembly 416 in which a detachable sensor 162 is embedded into the floor mat 416, and a sensor window 418 through which the wireless signal, infrared light for example, is emitted upward and is interrupted or reflected by the foot, when a foot is over the sensor (window). The window may be a cut out on the top side of the mat with a countersink or a recess for inserting the sensor. The sensor 162 has a wire harness 168 to receive power from the controller unit and transmit the signal to the controller unit to actuate a device or a solenoid valve 312 to turn on and off the water flow to the faucet valve or actuate a electromechanical device. The device may be a electromechanical valve or a calling bell for example. The sensor 162 may be a battery-operated sensor having a wireless transmitter, such as a Bluetooth transmitter, to transmit the stimuli/trigger wirelessly to a wireless receiver in the controller unit 160 which in turn operates the electromechanical valve (solenoid valve) or a mechanical device. The blue tooth transmitter may be integral with the sensor or separate from the sensor but connected to each other through wires. The sensor in this embodiment is emitting wireless signal 166 upward toward the ceiling. The wireless signal 163 is interrupted by the foot when the foot is over the sensor. As such, the foot has to be in a very specific area of the floor mat, and in the invention disclosed here, the foot has to be over the sensor or in the path of the IR signal that get reflected or interrupted for the sensor to trigger the sensor or foot is in the close proximity of the sensor. The interruption of the signal 163 by the foot is the stimuli and the solenoid valve opens for the flow of water for a pre-determined period of time. The water flow is cut off by the solenoid (electromechanical valve) when the foot moves away from the window 418. The size of the window may be about ¼ inch to an inch in diameter. The floor mat 416 is preferably made of water proof and softer material and may be about approximately 1.5 feet by 1.5 feet and the thickness depends on the size of the sensor, which may range from ¼ inch to an inch or so. The thickness of the floor mat is slightly thicker than the thickness of the sensor 162. The sensor window 418 may be just a cut out in the floor mat 416 or may have a scratch resistant glass as a cover to protect the sensor 162. The detachable sensor 162 provides for interchangeability of the floor mat wherein differently designed floor mats may be used. The floor mat may have a design or engraving or printing on the top, as shown in FIG. 27b. The design may be a picture or a word. The wire harness 168 is connected to the controller unit 160 through a detachable connector 168. The floor mat is similar to any normal floor mat used in kitchens and bathrooms, except this mat has sensor 162 installed into the floor mat.

The sensor 162 is not limited to Infrared, light emitting, motion sensing, temperature or proximity sensors. A pressure actuated switch, such as pressure sensor in a floor mat can also be used. The contactless sensor 164 and the electronic controller unit 300 may also be clamped to the drain pipe 180 underneath the sink. The stimuli to the sensors is not limited to moving the foot, or shifting weight, but can be other forms, such as moving sideways or moving the knees.

It is to be understood that the terminology which has been used is intended to be in the nature of words of description rather than of limitation. While there have been described herein, exemplary embodiments, other modifications shall be apparent to those skilled in the art from the teachings herein and, it is, therefore, desired to be secured in the appended claims all such modifications as fall within the true spirit and scope of the described and contemplated embodiments. The words solenoid valve, solenoid, and electromechanical are interchangeably used to describe a valve operated by a solenoid to turn on and off the flow through the plumbing, in which the solenoid valve is in series in a plumbing having an inlet from the main source and connected to a faucet.

### LIST OF ELEMENTS

100 Sink assembly
104 Faucet spout
105a Green light
105b Red light
106a handle 1
106b Handle 2
108 Soap spout
109 Soap dispenser
110 Sink
112 Bottom-Sink
114 Top-sink
115 Counter top bottom
120 Plumbing assembly
122 water inlet to 106a
126 Water inlet to 106b
130 Hot and cold water union
132 inlet to bypass valve 134
133 Tool pocket
134 Manual bypass valve
135 Tool boss
136 outlet from bypass valve
137 Manual valve handle
138 Water inlet to valve assembly 310
139 Water inlet to faucet spout
144 Soap bottle
146 Soap inlet to soap pump 320
148 Soap outlet to soap spout 108
160 Electronic control unit
162 Sensor 1
163 Wireless signal 1
164 Sensor 2
165 Wireless signal 2
166 Signal wire harness from the sensors for water regulation
167 Signal wire harness from the sensor for soap
168 Wire harness from the sensors
172 Right foot
174 Left Foot
176 Post
178 Base of the post
180 Drain pipe
199 Floor
200 Sink assembly with the cabinet
210 Cabinet
212 Cabinet Door
216 Cutout (Recess in the door/cabinet)
300 Controller unit
308 Wire harness to the valve (1 and 2)
310 Mechanical assembly
310a Integrated valves assembly
311 Solenoid/Motor
312 Electromechanical valve 1
314 Electromechanical valve 2
316 Valve body
320 Pump
322 Wire harness to the pump 320
402 Microphone/Sound signal receiver
410 Pressure sensing mat
412 High pressure mat
414 Low pressure mat
415 Mat assembly
416 Floor mat
418 Sensor window
A Angular width of the wireless signal
U Upper section of the sink assembly
L Lower section of the sink assembly

1. An automatic system for a sink assembly comprising:
at least one sensor attached to the bottom of the sink in the upper section of the sink assembly, said sensor emitting signal downward toward the floor, said signal interrupted by at least one foot of a human, at least one faucet spout, plumbing assembly having at least one electromechanical valve in series between an water inlet and a spout at the outlet, an electronic control unit underneath the sink, the electronic controller unit electrically connected to said electromechanical valve, said sensor communicating with the electronic controller unit, said interruption of signal in turn is actuating the said electromechanical valve through the electronic controller unit, electronic controller unit receiving power from an external power supply, electronic controller unit intermittently supplies power to the electromechanical valve per input parameters, at least one input parameter is the interruption in wireless signal from at least one sensor, another parameter is the pre-determined time.

2. Sensor as claimed in claim 1 is an infrared emitter and the receiver.

3. An automatic system for a sink assembly comprising:
a cabinet with at least one door, a sensor attached at the bottom of the cabinet, said sensor emitting signal downward toward the floor, said signal interrupted by at least one foot of a human, at least one faucet spout above the sink top, plumbing assembly underneath the sink, an electronic control unit underneath the sink, said electronic controller unit electrically connected to at least one electromechanical valve, at least one sensor communicating with the electronic controller unit, said interruption of signal in turn is actuating the electromechanical valve through the electronic controller unit, electronic controller unit receiving power from an external power supply, electronic controller unit intermittently supplies power to the electromechanical valve per input parameters, at least one input parameter is the interruption in wireless signal from at least one sensor, another parameter is the pre-determined time.

4. Sensor as claimed in claim 3 is an infrared sensor.

5. Sensor as claimed in claims 1 and 3 is the motion detection sensor.

6. Sensor as claimed in claims 1 and 3 is the light sensor.

7. At least one sensor of claims 1 and 3 is attached to a post and the post is immovably attached to the sink.

8. The floor mat assembly of claims 1 and 3 has a design on the top surface.

9. A foot actuated system for remotely activating a device comprising:
a floor mat assembly having at least one sensor embedded into a mat, said floor mat assembly is on the floor with the said sensor facing upward toward the ceiling and emitting IR light upward through the window in the mat, said sensor in the floor mat is in communication with an electronic controller unit, said electronic controller unit electrically connected to at least one device, said sensor is triggered by the human body, said trigger in turn actuates a device through the said electronic controller unit, said electronic controller unit receives power from an external power supply, said electronic controller unit intermittently supplies power to the device per input parameters, at least one input parameter is the signal triggered by placing the foot over the said sensor in the floor mat, another parameter is the pre-determined time.

10. A foot actuated automatic system for a sink assembly comprising:
a floor mat assembly having at least one sensor and a mat, said floor mat assembly is on the floor, said sensor in the floor mat is in communication with an electronic controller unit, said sensor is triggered by the human foot, said trigger in turn is actuating the electromechanical valve through the said electronic controller unit, at least one faucet spout, water plumbing connected to the said faucet, said plumbing system has at least one said electromechanical valve, said electronic controller unit electrically connected to said electromechanical valve, said electronic controller unit intermittently turning on and off the said faucet through said electromechanical valve, electronic controller unit receiving power from an external power supply, electronic controller unit intermittently supplies power to the electromechanical valve per input parameters, at least one input parameter is the signal triggered by placing the foot over the said sensor in the floor mat, another parameter is the pre-determined time.

11. Sensor in the floor mat as claimed in claims 9 and 10 is emitting IR signal upward.

12. The device of claim 9 is a solenoid valve.

13. The device of claim 9 is a soap dispenser.

14. The floor mat assembly of claims 9 and 10 has blue tooth transmitter.

15. Electronic controller unit of claims 7 and 8 has blue tooth receiver.

16. Sensor as claimed in claims 7 and 8 is an active infrared sensor having emitter and a receiver.

17. Sensor as claimed in claims 7 and 8 is a passive infrared sensor.
